(19) United States
(12) Patent Application Publication
(10) Pub. No.: US 2006/0202657 A1
(43) Pub. Date: Sep. 14, 2006

(54) Voltmeter relay with improved terminal coupling

(75) Inventor: Pietro Cecconi, Monza (IT)

Correspondence Address: YOUNG & THOMPSON, 745 SOUTH 23RD STREET, 2ND FLOOR, ARLINGTON, VA, 22202, US

(73) Assignee: ELECTRICA S.R.L., MILANO (IT)

(21) Appl. No.: 11/362,114

(22) Filed: Feb. 27, 2006

(30) Foreign Application Priority Data
Mar. 10, 2005 (IT) PC 2005 U 000004

(51) Int. Cl. H02P 1/24

(52) U.S. Cl. 318/727

(57) ABSTRACT

The present innovation relates to a voltage sensitive relay or starter relay for single-phase electric motors, in particular compressor motors, characterised in that it includes improved means of coupling the terminals onto which “faston” connectors are inserted.

More particularly, the innovation requires an elastic tooth (8) to be formed in the base-plate (5) of the terminals (3, 4), for example by semi-punching, and an opening to be made in the base (2) of the relay casing, in the wall of the seating (7) onto which said terminal base (5) is inserted, said opening being engaged by the snap-fitted tooth to lock the terminals into position. The result is a relay with firmly anchored terminals, which are not liable to be pulled out.

The present innovation relates to a voltage sensitive relay, or voltmeter relay, or starter relay for single-phase electric motors, in particular compressor motors, characterised in that it includes improved means of coupling the terminals onto which “faston” connectors are inserted.

More particularly, the innovation requires an elastic tooth to be formed in the baseplate of the terminals, for example by semi-punching, and an opening to be made in the base of the relay casing, in the wall of the seating onto which said terminal base is inserted, said opening being engaged by the snap-fitted tooth to lock the terminals into position.

The result is a relay with firmly anchored terminals, which are not liable to be pulled out.

Refrigerator motor-compressor assemblies, and many types of single-phase electric motors, are usually equipped with starting devices able to supply the motor with the pick-up current required for starting.

The motor/compressor assembly is generally made in a single hermetically sealed block, contained in a metal casing fitted with connectors suitable for connection to starter devices.

In numerous applications a relay is used as starting device, said relay being closed for as long as necessary to supply the pick-up current to the motor windings, and opened when the motor reaches the required number of revolutions.

Said relay is housed in a box-type container, generally made of plastic, fitted with jacks for application to the standard connectors present on the motor-compressor assembly, and with a number of terminals for the connection of auxiliary devices such as a thermostat, capacitor or the like.

The innovation relates to a starting device which presents a particular configuration designed to ensure better anchorage of said terminals.

In particular, in the relay according to the innovation, the terminals are inserted in a seating, the wall of which contains a cavity designed to receive a flexible tooth projecting from the base of the terminal, which said tooth is snapped into said seating and locks the terminal in position, preventing it from exiting from its seating, for example when the wires connected to the terminals are detached.

This innovation will now be described in detail, by way of example but not of limitation, by reference to the annexed figures, wherein:

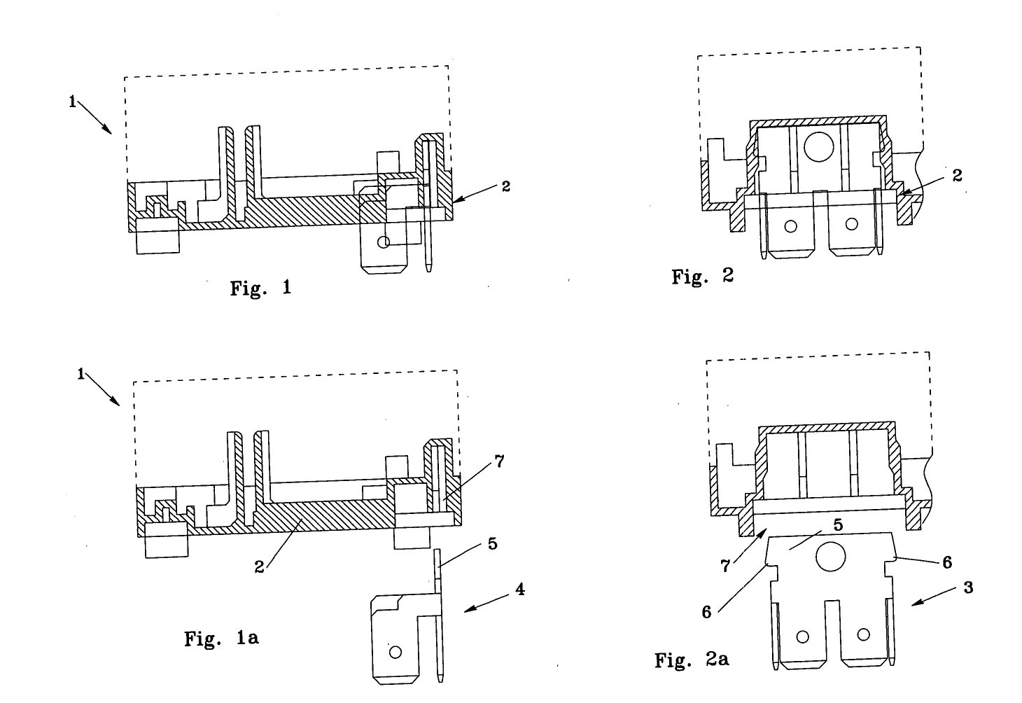

FIGS. 1 and 2 illustrate cross-sections along orthogonal planes of a detail of the header of a starter relay made according to the prior art, showing the part of the header in which the terminals are inserted;

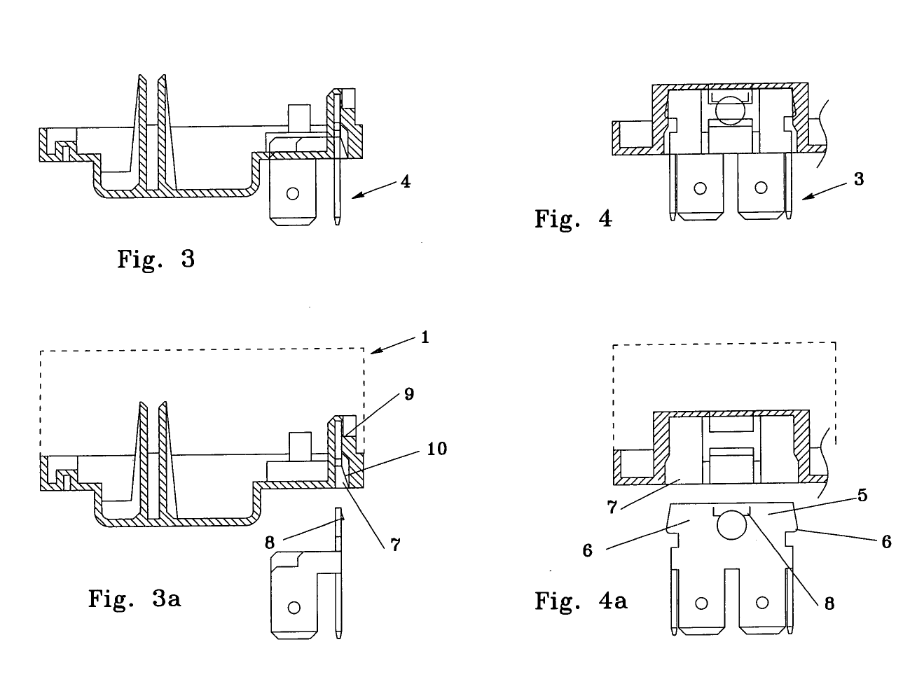

FIGS. 3 and 4 are cross-sections similar to the preceding ones, showing a starter relay according to the innovation;

FIGS. 1a to 4a show the same views of FIGS. 1 to 4, with the terminals separated from the header.

As shown in FIGS. 1 and 2, the components of the voltage sensitive relays are contained in a box casing 1 (shown by a broken line in the figures) fitted with a header 2 with connectors for assembly on a compressor casing.

A number of terminals 3 and 4 are fitted to header 2.

Said terminals comprise a base 5, with a pair of rigid teeth 6 at the edges, The width of the seating is such that the teeth are forced against its walls and tend to lock, preventing the terminal from exiting from the seating. However, as the casings of starter relays are usually made of plastic, when a faston is removed from the terminals, the necessary force is often sufficient to pull out the terminal, because the teeth are unable to gain sufficient purchase against the plastic of which the walls are made.

This drawback is remedied by the present innovation, as illustrated in the FIGS. 3 and 4, wherein the same components as in the preceding figures are indicated by the same reference numbers.

In accordance with the innovation, base 5 of the terminal is fitted with an elastic tooth 8, which can be constituted, for example, by a metal tab made by semi-punching in base 5 and bent towards the outside. An opening or cavity 9 will be made in the wall of seating 7, in the position in which tooth 8 is located when the terminal is inserted in the seating.

Seating 7 will preferably have a slightly counterbored mouth, to form a kind of guide that facilitates the insertion of the terminal, whereas the dimensions of the deeper part of the seating (thickness and width) will be equal to those of base 5.

This configuration is particularly convenient and practical.

It is convenient during assembly, because the counterbored mouth of seating 7 facilitates the insertion of base 5, which is then guided until it is fully inserted, sliding in contact with the walls.

Inclined wall 10 at the mouth of the base engages tooth 8, pushing it towards the interior until it retracts completely into base 5, thus facilitating the slide of the terminal when it is inserted. When the terminal has fully penetrated into the seating, tooth 8, which is positioned at opening 9, returns elastically to the outside, engaging the mouth of opening 9 and acting as anchorage element which, together with teeth 6, prevents the terminal from being pulled out.

The hole thus remains closed, and the relay can be used in environments containing inflammable materials, because any sparks near the movable contacts will remain totally confined to the interior of the casing.

An expert in the field could devise various modifications and variations, all of which should be deemed to fall within the ambit of this invention.

1) Starter relay for single-phase induction motors, and in particular compressor motors or the like, of the type comprising a header supporting the various devices which is fitted with seatings for the insertion, into said header, of one or more terminals, characterised in that it includes an elastic tooth projecting from the base of said terminals, and an opening in the wall of said seating, which said opening is positioned in correspondence with said tooth when the terminals are inserted into their seating, the dimensions of said seating corresponding exactly, in terms of width and thickness, to the dimensions of said terminal base.

2) Starter relay as claimed in claim 1, wherein said tooth is elastically deformable, so that it can bend and retract into the base when the terminal is inserted in the seating.

3) Starter relay as claimed in claim 2, wherein said tooth is made by semi-punching and deformation in the wall of the base.

4) Starter relay as claimed in claim 3, wherein the seatings for said terminals have a counterbored opening, with an inclined wall that presents the same inclination as the tooth, so that during insertion of the terminal the engagement between the tooth surface and said inclined wall causes the tooth to bend until it retracts fully into the base.

5) Starter relay as claimed in claim 1, wherein said opening is made in the wall of the relay header, in the area in which the tooth of the terminal is located when the terminal is inserted into its seating.
